(19) United States
(12) Patent Application Publication
(10) Pub. No.: US 2011/0153330 A1
(43) Pub. Date: Jun. 23, 2011

(54) SYSTEM AND METHOD FOR RENDERING TEXT SYNCHRONIZED AUDIO

(75) Inventors: Shawn Yazdani, Plano, TX (US); Amirreza Vaziri, Bethesda, MD (US); Solomon Cates, Scappoose, OR (US); Jason Kace, Boston, MA (US)

(73) Assignee: i-SCROLL, Rockville, MD (US)

(21) Appl. No.: 12/955,558

(22) Filed: Nov. 29, 2010

Related U.S. Application Data
(60) Provisional application No. 61/264,744, filed on Nov. 27, 2009.

(51) Int. Cl. G10L 13/00

(52) U.S. Cl. 704/260

(57) ABSTRACT

One or more computing devices include software and/or hardware implemented processing units synchronize a textual content with an audio content, where the textual content is made up of a sequence of textual units and the audio content is made up of a sequence of sound units. The system and/or method matches each of the sequence of sound units with a corresponding textual unit. The system and/or method determines a corresponding time of occurrence for each sound unit in the audio content relative to a time reference. Each matched textual unit is then associated with a tag that corresponds to the time of occurrence for the sound unit matched with the textual unit.

### CROSS-REFERENCE TO RELATED APPLICATIONS

This application is related to and claims priority to U.S. provisional patent application No. 61/264,744, filed Nov. 27, 2009, the corresponding specification of which is hereby incorporated by reference in its entirety.

### FIELD OF THE INVENTION

This invention relates to the field of content distribution in general and to content distribution systems that provide synchronized audio and text content in particular.

### BACKGROUND OF THE INVENTION

Traditional books have been in existence for several hundred years. For the most part, these traditional books have been printed or written into bound paper copies. Traditional paper books allow a reader to read pages as quickly as a reader desires, as well as quickly flip forward and backward through a book. Today however, technology has allowed for other mechanisms for delivering information in a book format.

Recently, electronic books or eBooks as they are often referred to have become a popular means for delivering printed information and text to readers. For the most part, eBooks do not alter the reading experience even though there are no paper pages that require turning. Most eBooks function in a similar manner to a paperback book in that an eBook recreates the static text of paper books. Thus, eBooks, by simulating paper-based books, subject themselves to paper based limitations and do not offer substantially different reading experiences.

One of the shortcomings of eBooks is that they can cause the user inconvenience and discomfort when the user continues reading through an electronic document viewer for a long time because the typographic images as reproduced on the character display of the electronic document viewer may be substantially poorer as compared with letters printed on paper, causing eyestrain.

Some devices have tried to overcome these shortcomings by using a paper like screen based on electrophoretic display, to create similar reading performance as conventional paper prints. However, digital content is very abstractive and not fitted to a visual standard as conventional paper products. Moreover, users may often find themselves in situation where they would like to access digital content but are unable to look at a display, e.g., like when a user is operating an automobile or walking down the street.

One solution for providing users eBook content in these situations is to synchronize audio with text. One known technique is disclosed in the U.S. Pat. No. 7,346,506 titled “System and method for synchronized text display and audio playback,” which discloses an audio processing system and method for providing synchronized display of recognized text from an original audio file and playback of the original audio file. The system includes a speech recognition module, a silence insertion module, and a silence detection module. The speech recognition module generates text and audio pieces. The silence insertion module aggregates the audio pieces into an aggregated audio file. The silence detection module converts the original audio file and the aggregated audio file into silence detected versions. Silent and non-silent blocks are identified using a threshold volume. The silence insertion module compares the silence detected original and aggregated audio files, determines the differences in position of non-silence elements and inserts silence within the audio pieces accordingly. The characteristics of the silence inserted audio pieces are used to synchronize the display of recognized text from an original audio file and playback of original audio file.

Other examples of synchronizing and simultaneously displaying text while playing audio are for example, television subtitles and music videos where lyrics may be shown. However, these conventional synchronization methods are specific in scope and limited in platform. Accordingly, there exists a need for providing text synchronized audio content on a wide array of platforms.

### SUMMARY

Briefly, according to the present invention, one or more computing devices comprise software and/or hardware implemented processing units, virtual and/or non-virtual, that synchronize a textual content, e.g., a book or other written material, with an audio content, e.g., spoken words, where the textual content is made up of a sequence of textual units, e.g., words, and the audio content is made up of a sequence of sound units. The system and/or method according to the present invention matches each of the sequence of sound units with a corresponding textual unit.

The system and/or method determines a corresponding time of occurrence for each sound unit in the audio content relative to a time reference. Each matched textual unit is then associated with a tag that corresponds to the time of occurrence for the sound unit matched with the textual unit. In one embodiment of the invention, such associating involves tagging each textual unit with a tag and associating the tag with the time of occurrence for the sound unit matched with the textual unit to create text synchronized audio (TSA) content comprising the sound units and tag associated textual units.

According to some of the more detailed features of the present invention, matching sound unit with corresponding textual unit involves retrieving the textual content and comparing the textual units with the sound units. The retrieval of the textual context may comprise a conversion process from another information format, such as spoken sound format. In one embodiment, the comparison involves comparing the textual unit with a vocalization corresponding to the sound unit. Alternatively, the comparison involves comparing the sound unit with a transcription corresponding to the textual unit. The matching sound unit with corresponding textual unit may require transcribing the sound unit or vocalizing the textual.

According to other more detailed features of the present invention, the sequence of sound units comprise a plurality of phoneme, which are segmental units of sound employed to form meaningful contrasts between utterances. Such sound units may also be a plurality of syllables, words, sentences or paragraphs. The sequence of textual units may be a plurality of signs, symbols, letters, characters, words, sentences or paragraphs.

According to another aspect, a TSA system according to the present invention has an audio content input configured to receive audio content that comprises a sequence of sound units. A textual content input is configured to receive textual content that comprises a sequence of textual units. A synchronizer synchronizes the textual content with audio content. The synchronizer has a matcher configured to match each of the sequence of sound units of the audio content with a corresponding textual unit of the sequence of textual units and a timer configured to determine a corresponding time of occurrence for each identified sound unit in the audio content relative to a time reference. Each matched textual unit is associated with a tag that corresponds to the time of occurrence for the sound unit matched with the textual unit.

### BRIEF DESCRIPTION OF THE DRAWINGS

The present invention will be more readily understood from the following detailed description when read in conjunction with the accompanying drawings, in which:

FIG. 1 shows an exemplary block diagram of a network for delivering text synchronized audio (TSA) content according to an exemplary embodiment of the present invention.

FIG. 2 shows an exemplary flow diagram for creating TSA content according to one embodiment of the invention.

FIG. 3 shows an exemplary block diagram of a system for synchronizing audio with text according to an exemplary embodiment of the present invention.

FIG. 4 shows an exemplary flowchart illustrating associating a time of occurrence with textual content according to an exemplary embodiment of the present invention.

FIG. 5 shows an exemplary flowchart illustrating the creation of TSA content from spoken content according to an exemplary embodiment of the present invention.

FIG. 6 shows an exemplary diagram of a user device for providing the TSA content to a user according to an exemplary embodiment of the present invention.

FIG. 7 shows an exemplary flowchart illustrating the creation of TSA content and rendering of the TSA content according to an exemplary embodiment of the present invention.

FIG. 8 shows an exemplary flowchart tags are used for rendering TSA content to a user according to an exemplary embodiment of the present invention.

FIG. 9A shows an exemplary graphical user interface for synchronously displaying the text with audio according to an exemplary embodiment of the present invention.

FIG. 9B shows an exemplary graphical user interface for interacting with the text of the TSA content according to an exemplary embodiment of the present invention.

FIG. 9C shows an exemplary graphical user interface for selecting display options for the text according to an exemplary embodiment of the present invention.

FIG. 9D shows an exemplary graphical user interface for browsing TSA application according to an exemplary embodiment of the present invention.

FIG. 9E shows an exemplary graphical user interface for a menu of actions on a user device according to an exemplary embodiment of the present invention.

FIG. 9F shows an exemplary graphical user interface of a user content library according to an exemplary embodiment of the present invention.

FIG. 9G shows an exemplary graphical user interface of a virtual shelf of a user content according to an exemplary embodiment of the present invention.

FIG. 10 shows an exemplary graphical user interface of a device with an application for providing TSA content installed.

FIG. 11 shows an exemplary block diagram of a system using a core reader application according to an exemplary embodiment of the present invention.

FIGS. 12A and 12B show exemplary contents of an XML file containing information for TSA content.

FIG. 13 shows an exemplary block diagram of dataflow in a system using a core reader application according to an exemplary embodiment of the present invention.

FIG. 14 shows an exemplary block diagram of a system for previewing TSA content using a core reader application according to an exemplary embodiment of the present invention.

FIG. 15 shows an exemplary diagram of a system for providing text synchronized audio content according to an exemplary embodiment of the present invention.

FIG. 16 shows another exemplary graphical user interface of a login to the TSA content portal according to an exemplary embodiment of the present invention.

FIG. 17 shows another exemplary graphical user interface of a social networking with an integrated TSA content portal according to an exemplary embodiment of the present invention.

### DETAILED DESCRIPTION OF THE INVENTION

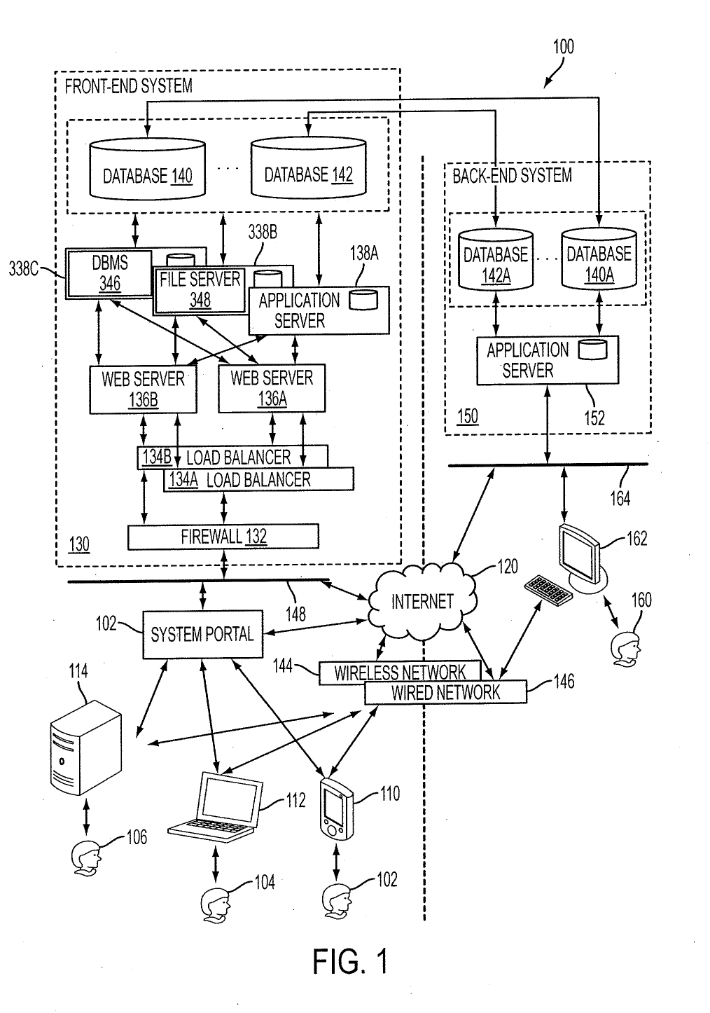

FIG. 1 shows an exemplary block diagram of a system 100 for delivering text synchronized audio (TSA) content according to an exemplary embodiment of the present invention. TSA content delivered to the user devices is created by synchronizing textual content with audio content. Textual content comprises a sequence of textual units, e.g., words, phrases, clauses, paragraphs, etc. Audio content (spoken or synthesized) comprises a sequence of sound units, e.g., syllables. A user device that receives TSA content may include any type of electronic device, such as a handheld device (e.g., iPhone®, Blackberry®, Kindle®), personal digital assistant (PDA), handheld computer, a laptop computer, a desktop computer, a tablet computer, a notebook computer, a personal computer, a television, a smart phone, etc.

Once TSA content is delivered to a user device, it is rendered, for example, by synchronous highlighting of text while audio is being played. The audio content can correspond to any communication which may be represented in text, whether vocalized by a human or synthesized by mechanical or electrical means. Such communications may be for example, a speech, a song, an audio book, poem, short stories, plays, dramas, interviews, etc.

According to this embodiment, the system 100 of FIG. 1 includes a front-end system 130 and a back-end system 150. The front-end system 130 provides TSA content to the user devices 110, 112, 144 for rendering. The front-end system 130 also provides users 102, 104, 106 an online environment wherein users 102, 104, 106 may access TSA content, create new TSA content, modify existing TSA content, and share TSA content with other users 102, 104, 106, for example, within a social networking environment, such as the YouTube, Picasa, Facebook, etc.) or a portal environment. The back-end system 150 is used for system administration, content development and implementation, information record keeping, as well as application developments for billing, marketing, public relations, etc.

The front-end system 130 interfaces with the user devices 110, 112, 114, allowing users 102, 104, 106 to interact with the online environment. The user devices 110, 112, and/or 104 are coupled to the system portal 140 via a network 142, which may be a LAN, WAN, or other local network. The system portal 140 acts as a gateway between the front-end system 120, the user devices 110, 112, and/or 114. Alternatively, the user devices 110, 112, and/or 114 may be coupled to the system portal 140 via the Internet 142 or through a wired network 146 and/or a wireless network 144.

In an exemplary embodiment, for receiving TSA content, the user devices 110, 112, 114 execute a network access application, such as a browser or any other suitable application or applet, for accessing the front-end system 130. The users 102, 104, 106 may be required to go through a log-in session before receiving access to the online environment. Other arrangements that do not require a log-in session may also be provided in accordance with other exemplary embodiments of the invention. The TSA content could also be delivered to the user device via an external storage device, such as a memory stick or CD.

In the exemplary embodiment shown in FIG. 1, the front-end system 130 includes a firewall 132, which is coupled to one or more load balancers 134a, 134b. Load balancers 134a-b are in turn coupled to one or more web servers 136a-b. To provide the online environment, the web servers 136a-b are coupled to one or more application servers 138a-c, each of which includes and/or accesses one or more front-end databases 140, 142, which may be central or distributed databases. The database can store various types of content, including audio, textual or TSA content. The application servers serve the interface of the online environment according to the present invention. The application servers also serve various modules used for interaction between the different users of the online system

Web servers 136a-b provide various users portals. The servers 136a-b are coupled to load balancers 134a-b, which perform load balancing functions for providing optimum online session performance by transferring client user requests to one or more of the application servers 138a-c according to a series of semantics and/or rules. The application servers 138a-c may include a database management system (DBMS) 146 and/or a file server 148, which manage access to one or more databases 140, 142. In the exemplary embodiment depicted in FIG. 1, the application servers 138a and/or 138b provide the online to the users 102, 104, 106. Some of the content presented is generated via code stored either on the application servers 338a and/or 338b, while some other information and content, such as user profiles, user information, TSA content, TSA content information, or other information, which is presented dynamically to the user, is retrieved along with the necessary data from the databases 140, 142 via application server 138c. The application server 138b may also provide users 102, 104, 106 access to executable files which can be downloaded and installed on user devices 110, 112, 114 to render TSA content to users 102, 104, 106. Installed applications may have branding and/or marketing features that are tailored for a particular application or user.

The central or distributed database 140, 142, stores, among other things, the TSA content provided to user devices 102, 104, 106. The database 140, 142 also stores retrievable information relating to or associated with users, profiles, billing information, schedules, statistical data, user data, user attributes, historical data, demographic data, billing rules, third party contract rules, etc. Any or all of the foregoing data can be processed and associated as necessary for achieving a desired objective associated with operating the system of the present invention.

Updated program code and data are transferred from the back-end system 150 to the front-end system 130 to synchronize data between databases 140, 142 of the front-end system and databases 140a, 142a of the back-end system. Further, web servers 136a, 136b, which may be coupled to application servers 138a-c, may also be updated periodically via the same process. The back-end system 150 interfaces with a user device 162 such as a workstation, enabling interactive access for a system user 160, who may be, for example, a developer or a system administrator. The workstation 162 is coupled to the back-end system 160 via a local network 164. Alternatively, the workstation 162 may be coupled to the back-end system 150 via the Internet 142 through the wired network 146 and/or the wireless network 144.

The exemplary embodiment of the present invention makes reference to, e.g., but not limited to, communications links, wired, and/or wireless networks. Wired networks may include any of a wide variety of well known means for coupling voice and data communications devices together, which may be virtual or non-virtual networks. A brief discussion of various exemplary wireless network technologies that may be used to implement the embodiments of the present invention now are discussed. The examples are non-limiting. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc.

The back-end system 150 includes an application server 152, which may also include a file server or a database management system (DBMS), supporting either virtual or non-virtual storage. The application server 152 allows a user 160 to develop or modify application code or update other data, e.g., electronic content and electronic instructional material, in databases 140a, 142a. A user 160 may also use the back-end system for the creation, modification, or removal of TSA content.

It would be appreciated that the system shown in FIG. 1 could be implemented in or make use of various cloud computing service. Software-as-a-Service (SaaS) is a model of software deployment whereby a provider licenses an application to customers for use as a service on demand. One example of SaaS is the Salesforce.com CRM application. Infrastructure-as-a-Service (IaaS) is the delivery of computer infrastructure (typically a platform virtualization environment) as a service. Rather than purchasing servers, software, data center space or network equipment, clients instead buy those resources as a fully outsourced service. One such example of this is the Amazon web services. Platform-as a-Service (PaaS) is the delivery of a computing platform and solution stack as a service. PaaS facilitates the deployment of applications without the cost and complexity of buying and managing the underlying hardware and software layers. PaaS provides the facilities required to support the complete lifecycle of building and delivering web applications and services. An example of this would the GoogleApps. In various, but not all embodiments of the invention, computer languages may be used which include, but are not limited to, C, C++, Python, Objective-C, HTML, Java, and JavaScript. Other programming languages may be employed as well.

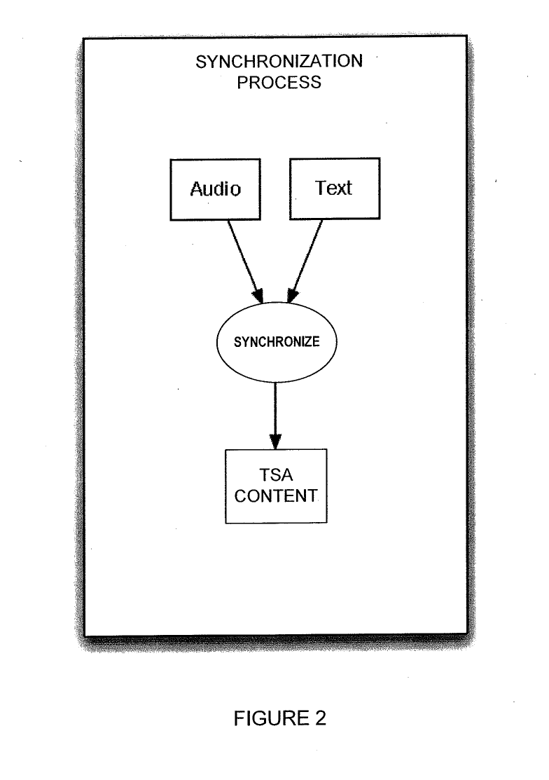

FIG. 2 shows a flow diagram of a system that synchronizes audio content with textual content via a synchronizer that produces TSA content. In one embodiment, the synchronizer acts as an aligner that aligns audio content with textual content such as a book. As such, the synchronizer uses an alignment algorithm that produces an aligned TSA content (book). The present invention applies to various rendering models. Under an “application” model, the TSA content is embodied in an executable application that can be executed by a user device, such as an iPod application. Under the reader model, the TSA content comprises a file that could be read by a reader application in the user device.

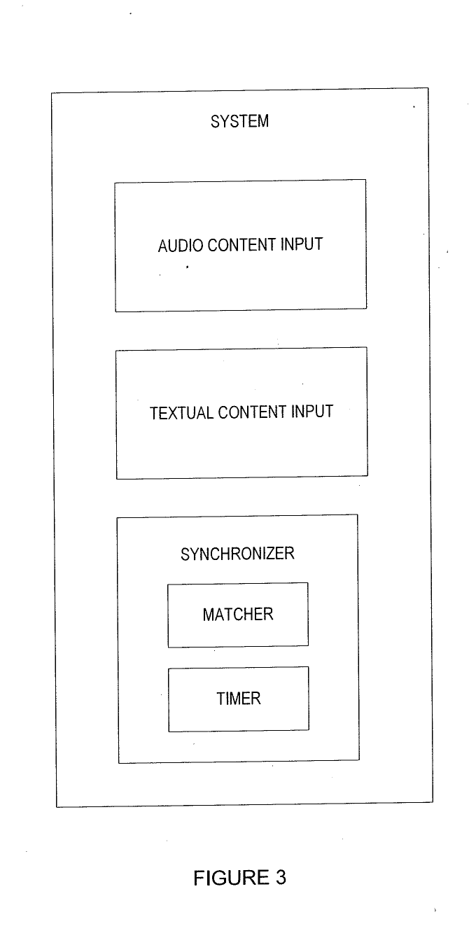

FIG. 3 shows an exemplary block diagram of a system for synchronizing audio content with textual content according to an exemplary embodiment of the present invention. The system includes an audio content input configured to receive audio content that comprises a sequence of sound units. The audio content input can be hardware based, software based, or a combination. Audio content is information representing sound, such as, e.g., but not limited to, an audio file, a Waveform Audio File Format (WAV) file, MPEG-1 or MPEG-2 Audio Layer 3 (or III) (MP3) file, Free Lossless Audio Codec (FLAC) file, Windows Media Audio (WMA) file, etc. Examples of sound units of the audio content include, but are not limited to, phoneme (the smallest segmental unit of sound employed to form meaningful contrasts between utterances), syllables, words, sentences, paragraphs, etc.

The system further includes a textual content input configured to receive textual content that includes a sequence of textual units. The textual content input can be hardware based, software based, or a combination. Textual content is information representing a coherent set of symbols that transmits some kind of informative message, such as, e.g., but not limited to, a text (TXT) file, a comma separated values (CSV) file, a Microsoft Word (DOC) file, a HyperText Markup Language (HTML) file, a Portable Document Format (PDF) file, etc. Examples of textual units of the textual content include, but are not limited to, signs, symbols, letters, characters, words, sentences, paragraphs, etc.

The synchronizer synchronizes the textual content with audio content. The synchronizer includes a matcher configured to match each of the sequence of sound units of the audio content with a corresponding textual unit of the sequence of textual units. The synchronizer further includes a timer configured to determine a corresponding time of occurrence for each identified sound unit in the audio content relative to a time reference, wherein each matched textual unit is associated with a tag that corresponds to the time of occurrence for the sound unit matched with the textual unit. As herein defined, a tag is a term assigned to a piece of information. The text tagged with corresponding time of occurrences can serve as an acoustic model. An acoustic model can be a map of the voice in relation to a series of printed words. The synchronizing system could be incorporated in the front-end system or back-end system. However, in alternate embodiments the system may also, or instead, be incorporated on a user device.

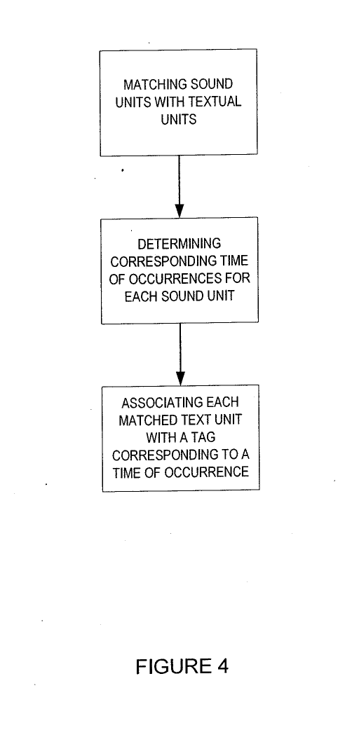

FIG. 4 shows an exemplary flowchart illustrating associating a time of occurrence with textual content according to an exemplary embodiment of the present invention. The flowchart represents how the system of FIG. 3 synchronizes textual content with audio content. The flowchart represents an execution method in a computer for synchronizing textual content, whether received or generated, that includes a sequence of textual units with an audio content, whether spoken or synthesized, that includes a sequence of sound units.

The flowchart begins with matching each of the sequence of sound units of the audio content with a corresponding textual unit of the sequence of textual units. In one embodiment, the textual content already exists in the system and is retrieved from storage. In another embodiment, retrieving the textual content includes receiving information and converting the information into textual content. For example, a scanned image of a document can be translated into textual content based on using optical character recognition (OCR). The retrieved textual content is then compared with the sound units of the audio file. The textual content is compared with the sound units by transcribing a sound unit and identifying the text unit in the textual content corresponding to the transcription of the sound unit. Accordingly, in this embodiment, comparison is performed based on comparing two texts. For example, the audio includes the sound unit corresponding to “whole.” The sound unit is transcribed as the text “whole,” and the textual content is compared with the transcription for textual unit corresponding to “whole.” As the sound units can have multiple transcriptions, for example, the sound “whole” is similar to the sound for “hole,” the comparison can account for discrepancies in transcription. In an embodiment, a dictionary identifies textual units with similar sounds and also searches the textual content for similar sounding textual units. The comparison process can also utilize the fact that because the synchronization process is sequential, the first unsynchronized sound units will typically correspond to the first unsynchronized textual units.

To transcribe the sound units speech recognition algorithms can be used. Speech recognition algorithms can include acoustic model programming that allows the algorithm to recognize variations in pronunciation. Algorithms can use patterns in the sound of the speaker's voice to identify words in speech. Speech recognition algorithms can also account for grammatical rules using a language model. A language model can capture properties of a language to predict the next word in a speech sequence.

In an alternate embodiment, the comparison process includes vocalizing a textual unit as sound and identifying the sound unit in the audio content that corresponds to the vocalized sound. Accordingly, in this embodiment comparison is performed based on comparing two sounds. Similarly to textual comparison, the process can account for different possible vocalizations of a textual unit.

In the case where textual content is not initially available, for matching purposes the sound units of the audio content are transcribed into textual units which are considered to be the corresponding matched textual units of the sound units they are transcribed from. In the case where audio content is not initially available, for matching purposes, the textual units are vocalized as sound units which are considered to be sound units matching the textual units they are vocalized from.

As shown in the flowchart, the method further includes determining corresponding time of occurrence for each sound unit in the audio content relative to a time reference. The determination of corresponding time of occurrences can occur 1) before the above matching is done, 2) while the matching is done or 3) after the matching is done. The time of occurrence for a sound unit is the time that a sound unit occurs in the audio content, relative to a time reference. Typically, the time reference is the beginning of the audio content whereby the time of occurrence marks time from the beginning of the audio content. A time of occurrence for one sound unit may also be relative to another time of occurrence of a previous sound unit.

The flowchart further shows the method includes associating each matched textual unit with a tag that corresponds to the time of occurrence for the sound unit matched with the textual unit. A tag is a label representing information. An example of a tag includes a markup language tag. Markup languages include systems for annotating text in a way that is syntactically distinguishable from that text, for example, HyperText Markup Language (HTML), XML (Extensible Markup Language), etc. The tag corresponds to the time of occurrence that the sound unit matched with the textual unit occurs in the audio content.

In one embodiment, associating includes first tagging each textual unit with a tag. Associating further includes associating the tag with the time of occurrence for the sound unit matched with the textual unit. For example, the output of a tagging software, process or algorithm could be an HTML formatted file which surrounds each and every word with a markup tag which is identified by a numeric id. Each tag may then be associated with the exact time the word is spoken in the audio content. Since many words may be spoken in less than a second, there can be multiple id's that are associated to the same, or nearly the same time.

Additionally, the time/id data may be indexed into at least two arrays to improve look up speed. One array may be indexed by time which associates with marked up html tags in the document and the other may be indexed by ids of the HTML tags relating to the times words are spoken in the audio content. The example of one embodiment below illustrates this point:

### Array 1:

time:10sec, tag_id:1
time:11sec, tag_id:2
time:12sec, tag_id:4

### Array 2:

tag_id=1, time:10,03sec
tag_id=2, time:11,23sec
tag_id=3, time:11.54sec
tag_id=4, time:12.21sec

The synchronizing method can further include outputting TSA content comprising the sound units and tag associated textual units. The TSA content for the audio content and textual content is output as a single package. The single package is further referred to below as a “title” and/or as a “scroll.”

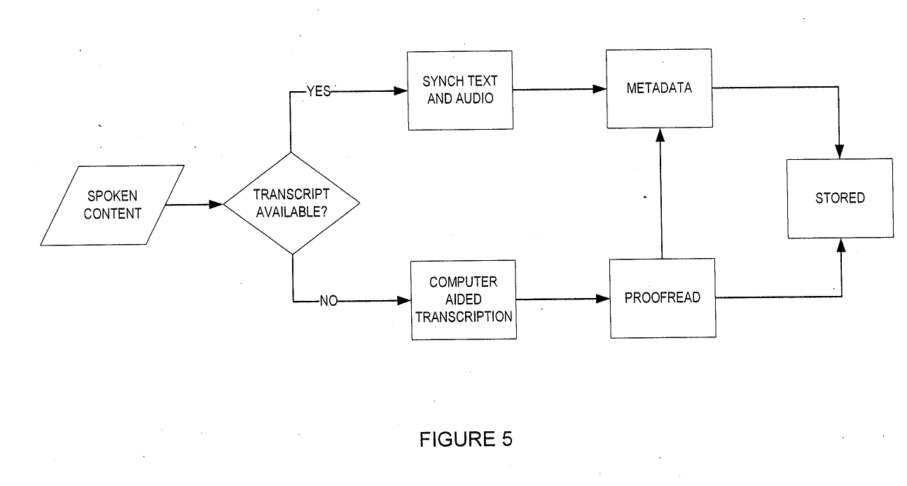

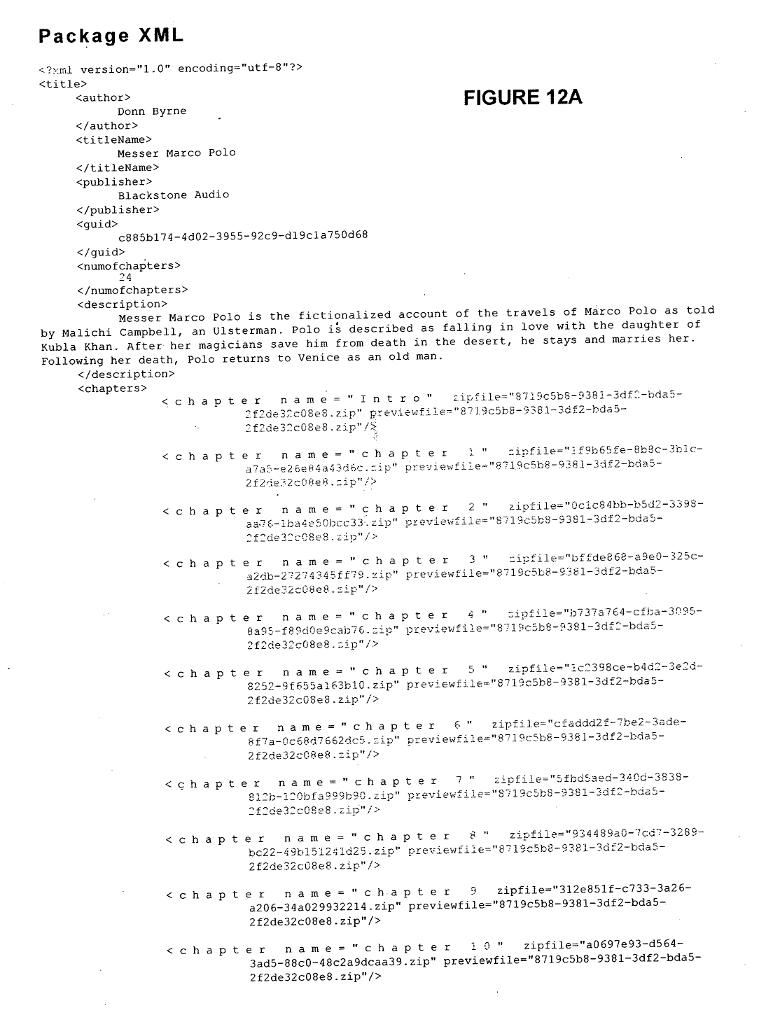

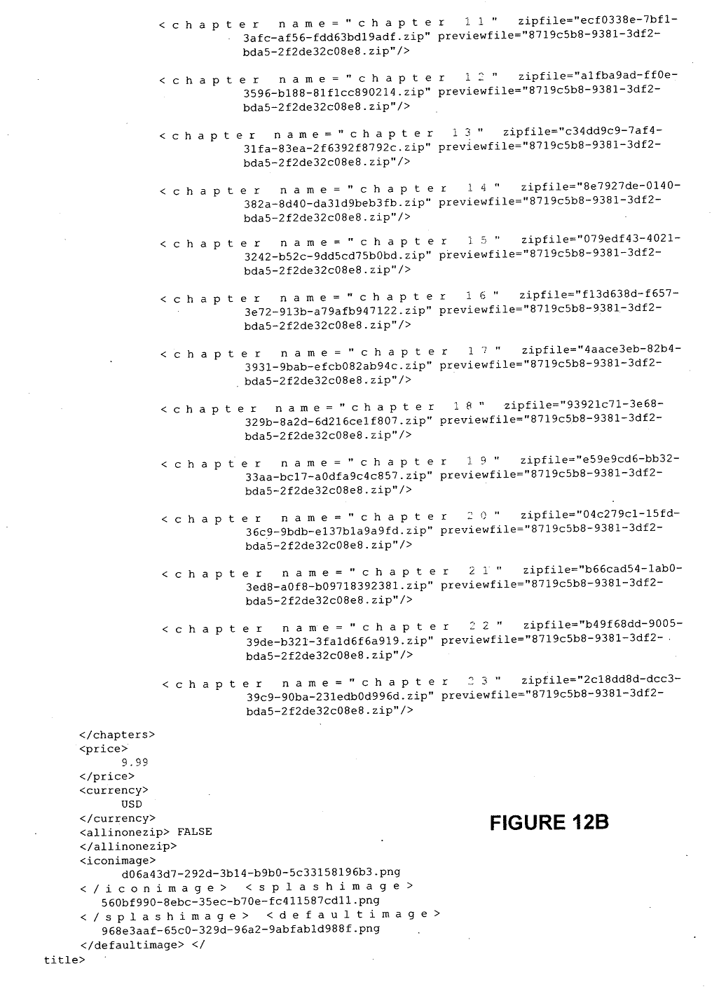

FIG. 5 shows an exemplary flowchart illustrating the creation of TSA content from spoken content according to an exemplary embodiment of the present invention. The flowchart begins with audio information corresponding to spoken content. The creation process then determines if a transcript is available of the spoken content. If a transcript is available, the text of the transcript and spoken content is synchronized. The synchronization is based on the process previously described for FIG. 4. After synchronization, metadata is added to the TSA content. Metadata can include information defining the author, speaker, title, price, description, etc., for the TSA content. Metadata can be added in the form of a separate XML files, which are described in detail below in connection with FIGS. 12A and 12B.

If a transcript is not available of the spoken content, the spoken content is transcribed with the aid of a computer. The computer transcription process can also determine a level of confidence for the accuracy of the transcription. During the transcription process, the spoken content can be simultaneously transcribed and synchronized with the transcribed text as previously discussed. The text can then be manually proofread. The proofreading can be based on the level of confidence of the transcription whereby for extremely high levels of confidence, no proofreading is done, and low levels of confidence, a comprehensive proofreading is performed. After proofreading metadata can also be added to the now TSA content.

The TSA content and metadata are then stored for later retrieval. In one embodiment, the TSA content and metadata are stored as a single package. The single package can be stored as a ZIP file, a Roshal Archive (RAR) file, a directory of files, etc.

An example of a HTML formatted file with tags is shown below.

<script>
times_indexed_by_id = [0,0,0,1,1,5,5,6,6,6,6]
ids_index_by_time = [3,4,4,4,5,9,11]
</script>
<p class=“p1”>
<span id=“1”>A </span>
<span id=“2”>Visit </span>
<span id=“3”>To </span>
<span id=“4”>Niagara</span>
</p>
<p class=“p1”>
<span id=“5”>NIAGARA </span>
<span id=“6”>FALLS </span>
<span id=“7”>is </span></p>
<span id=“8”>a </span>
<span id=“9”>most </span>
<span id=“10”>enjoyable </span>
<span id=“11”>place.</span>
</p>

Each of the words in the textual content is separately tagged with a unique identification. In the example the identification (id) is a number that is incremented based on the position of the word in the sequence of words. The HTML file begins with an array of times indexed by id. The position of each element in the array corresponds to an id of a word. As can be seen in the text above, the first element in the array is given a position 1, which corresponds to the word “A” in the text. The values of the elements indicate the time of occurrence for the text. For the first element, the value is “0,” indicating that the word “A” occurs at time “0.” The elements in the second and third position also have the value “0” because the words “Visit” and “To” occur in the audio in the same second which “A” occurs. The fourth element, corresponding to “Niagara” which is tagged with the id 4, is shown to occur at time “1,” one second into the audio.

Each word, syllable or phrase in the text-based content is associated with a specific audio time stamp in the corresponding audio file. These time stamps are relative to a 1× playback speed and represent the time elapsed from the beginning of the audio file until this word, syllable or phrase is played. In the HTML formatted text content, each word, syllable or phrase is tagged with a unique variable or id that is used as an index into a data structure of time stamps. The data structure of time stamps contains a mapping of each unique HTML tag to a specific time and can be searched both by tag and by the time stamp.

While the example shown above only associates textual content with a granularity of one second, tags can also indicate the starting millisecond that a word occurs, the starting second in which a syllable occurs, or the starting millisecond that a syllable occurs. Additionally, the time of occurrence for textual units can also be represented in other forms than arrays of elements.

Synchronization can be performed to align the textual content and audio content prior to the users of the user devices interacting with the user device. Synchronization can also align textual content and audio content while the user is interacting with the user device.

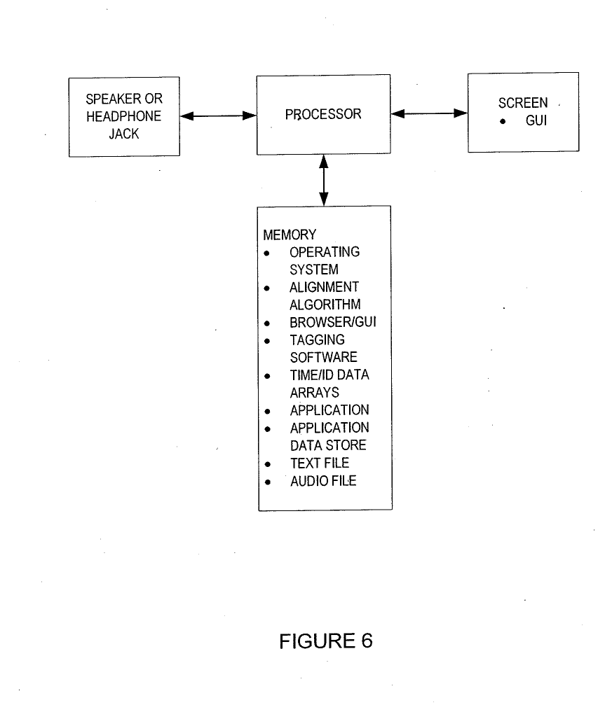

FIG. 6 shows an exemplary diagram of a user device for providing the TSA content to a user according to an exemplary embodiment of the present invention. In the exemplary embodiment, the user device includes a processor for processing TSA content. The user device further includes a display, such as, e.g., a screen, a touch screen, a liquid crystal display (LCD), etc., configured to display the textual content of the TSA content. Additionally, the user device includes an audio content output, for example, a speaker, headphone jack, etc.

The user device also includes memory for storage. The memory stores an operating system for operating the user device, an alignment algorithm for synchronizing the textual content and audio content, a browser/graphical user interface (GUI) for a user to interface with the user device, time/id data arrays indicating the time a textual unit corresponding with the id occurs in the audio content, an application for rendering the TSA content, an application data store for storing the TSA content, a text file corresponding to the textual content, and an audio file corresponding to the audio content.

The application uses the processor to process TSA content retrieved from storage and output the audio content and textual content of the TSA content. The application uses the audio content output of the device to playback the audio to the user and uses the display of the device to show textual content. The application itself is also stored in memory on the device.

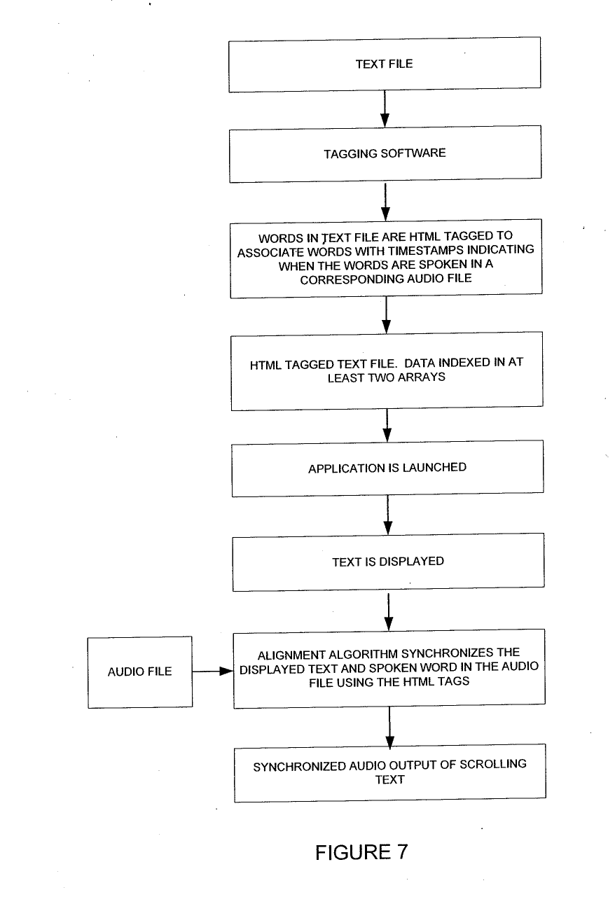

FIG. 7 shows an exemplary flowchart illustrating the creation of TSA content and the rendering of TSA content to a user according to another exemplary embodiment of the present invention. The creation of TSA content is similar to the synchronization process described above for FIGS. 4 and 5. The process begins with a text file and tagging software is run on the text file to create tags for each word in the text file. After the tags are added to text file, these tags are then associated with the time of occurrence for the words corresponding to the tags using the array of time indexed by ids and the array of ids indexed by time. The time associated and tagged text can be a HTML tagged file.

After the content is synchronized, the application on a user device is then launched to render the TSA content. The textual content of the TSA content is displayed. The application then retrieves the audio content, for example, from an audio file. The audio file is then rendered and the application uses an alignment/synchronization algorithm to align/synchronize the display on the text based on the rendering of the audio. The text is scrolled along with the rendering of the audio so that the currently spoken text is centered in the display at all times.

Scrolling text and synchronized human audio narration can be appealing to viewers and result in increased comprehension by readers. TSA content which is scrolled may be particularly appealing to young readers, learning disabled students and traditional audio book users.

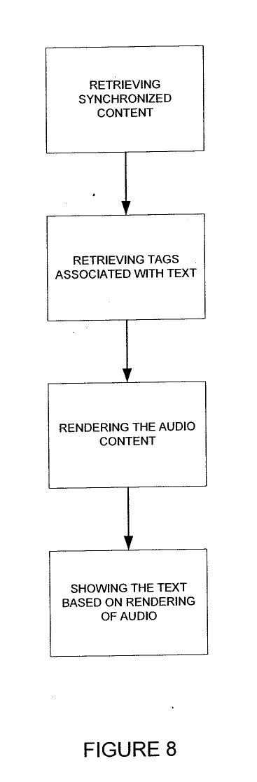

FIG. 8 shows an exemplary flowchart illustrating how tags are used for rendering of the TSA content, according to an exemplary embodiment of the present invention. In the exemplary embodiment, a user device retrieves TSA content including textual content having a sequence of textual units and audio content having a sequence of sound units. The user device then retrieves tags associate with the textual units from the TSA content. Each tag corresponds to a time of occurrence of the sound unit in the audio content matching the textual unit. The audio device then renders the audio content and shows the textual unit, corresponding to the currently rendered sound unit of the audio content, on a display of the device. The display is based on the rendering of the audio content according to the time of occurrence of the sound unit in the audio content matching the textual unit.

To show the textual unit synchronously with the rendering of the audio, the device can determine the time a sound unit is rendered relative to a time reference. Thus, the device knows how many seconds into the audio content the device is rendering. The device then determines the textual unit with a time of occurrence corresponding to the time the sound unit is rendered. Accordingly, when rendering a sound unit determined to occur twenty seconds into the audio content, the device displays the textual unit with a time of occurrence of twenty seconds.

As an example of rendering in a browser using a HTML document, the device runs a process that continuously notifies the embedded browser what the current time is within the audio file. JavaScript can be used to determine the time passed in from the audio. The elapsed time is used by the process to look up the array indexed by time to determine which current word is being spoken and where it is located in the HTML document. Based on the current word for the elapsed time indicated by the array and the location of the current word in the HTML, the process continually attempts to keep the current word for the elapsed time shown in a designated area of the display. As the elapsed time increases while the audio is being rendered, the current word indicated by the array to correspond with the elapsed time also changes. The JavaScript can continue to determine whether to speed up or slow down the scroll speed of the document based on where the current spoken word is on the page and how long the JavaScript estimates it will take to get to the following lines of text. Estimating the time needed can make the scrolling as smooth as possible while maintaining a high level of accuracy.

Displaying the textual unit while the corresponding sound unit is being rendered can include highlighting the textual unit on the display. Highlighting includes emphasizing, marking, making prominent, etc. For example, the text corresponding to the currently rendered audio may change in size, color, line spacing and font as it is displayed in a sequence.

Using a “seek” feature, users can also arrive to specific times in the audio while displaying synchronized text. Alternatively, users can arrive to specific textual units or locations within the text, where the application will then render the audio content based on the time of occurrence corresponding to the tag associated with the textual unit. For example, a user can skip ahead or go back in the document by using a one-fingered swiping motion up or down on the screen. The user can also skip ahead or go back using preprogrammed buttons in the interface or on the device itself. When swiping to a new location in the text, the JavaScript algorithm can determine the first word in the line of text now shown in the center of the display. The algorithm can also determine a word shown in another designated area of the display. The algorithm can then determine the id associated with the identified word shown in the display. In this procedure the id list may be used to determine the time the audio file needs to fast forward or rewind to in order to re-sync the audio with the new position in the user's view on the screen in the HTML. Once a time is found the HTML may be re-centered in the middle, or other designated area, of the screen and the audio based control takes over once again, as described previously.

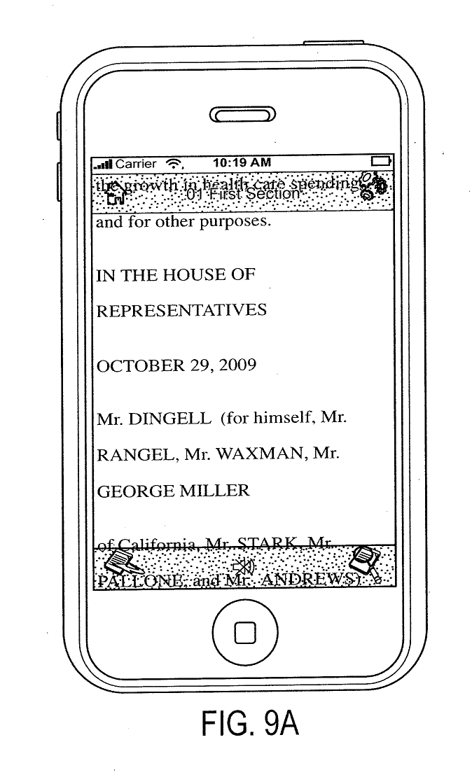

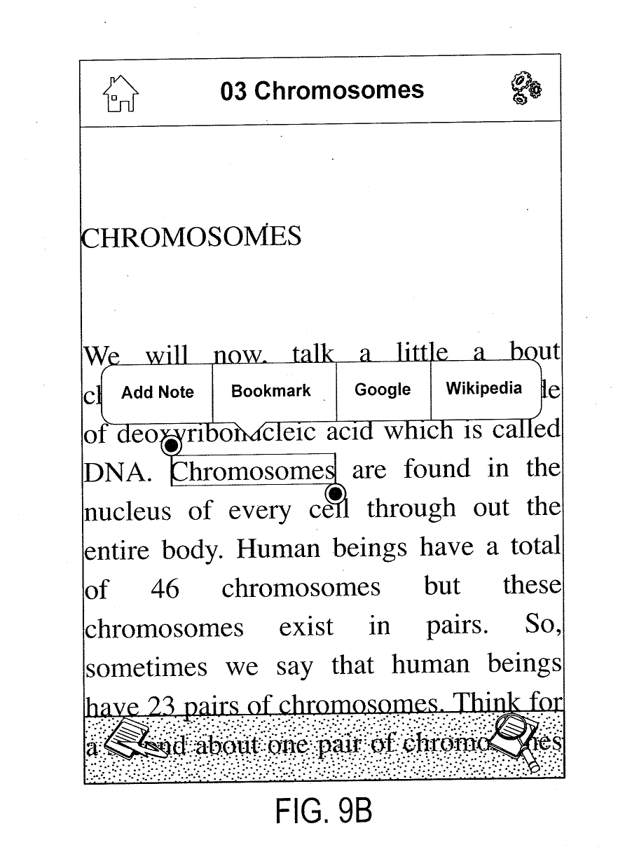

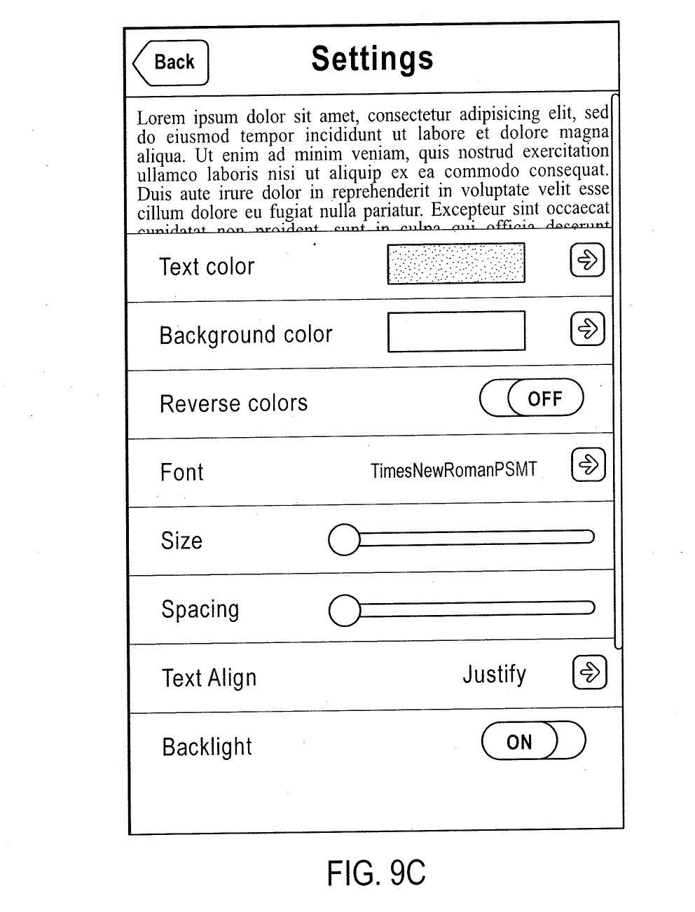

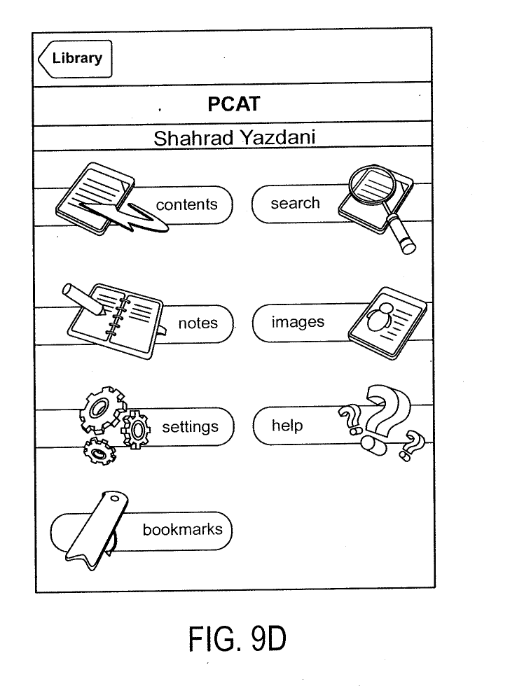

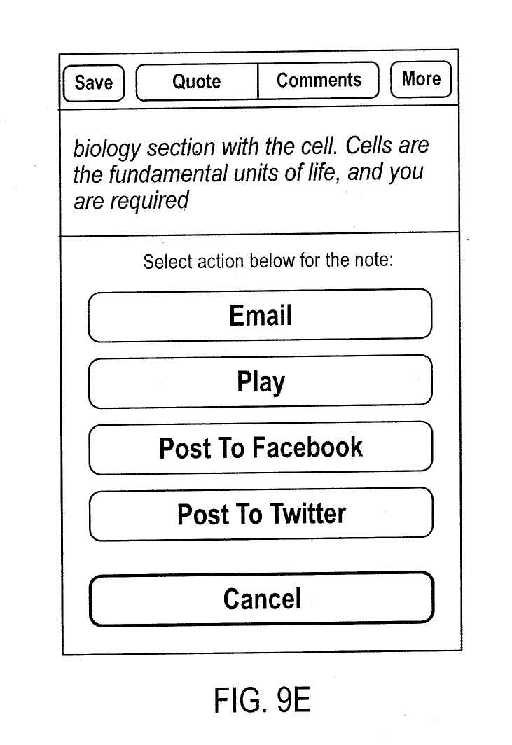

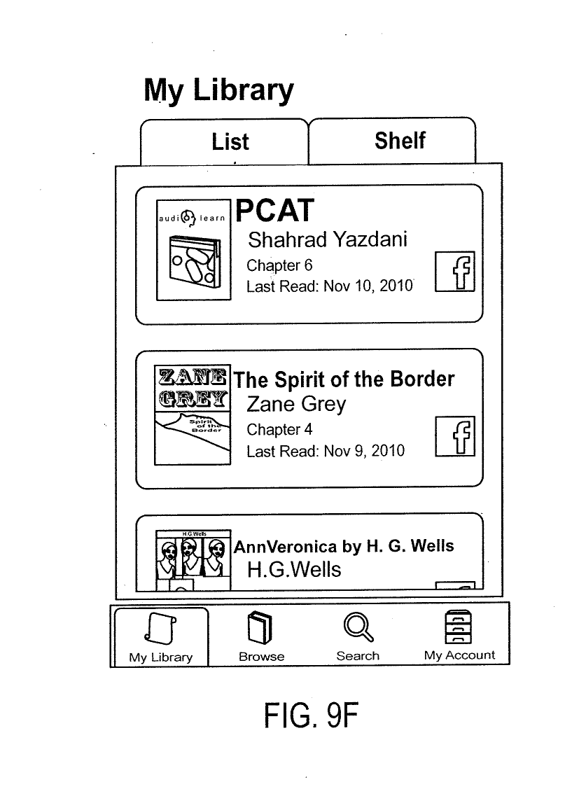

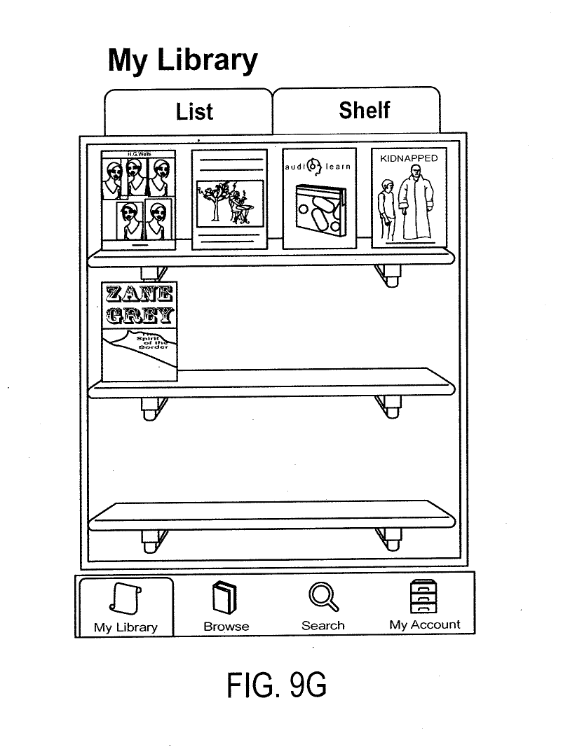

FIG. 9A shows an exemplary graphical user interface (GUI) for synchronously displaying the text with audio according to an exemplary embodiment of the present invention. The GUI for reading provides a number of features. As previously described, one feature of the GUI is that the GUI renders TSA content for a reader. The user interface can playback the audio, and display the text of the book in the GUI. Amongst other things, the user may be able to select the chapter to play, audio levels, audio speed, playback language, size of font, and bookmark the book via the GUI. A reader can have the option to control various aspects of the application such as, but not limited to, viewing only the text or listening strictly to the audio portion. A reader may be able to choose to view only the scrolled text, listen to only the audio narration by turning off the display, or combine both options. Users can also view the content in its natural forward progression, pause and or stop and re-read a section, return to an earlier section and or skip to a later section with one-touch scrolling. Furthermore, users can view the text in a stationary mode, typically seen in a traditional eBook. Text can also be viewed in portrait or landscape mode.

FIG. 9B shows an exemplary graphical user interface for interacting with the text of the TSA content according to an exemplary embodiment of the present invention. Users can highlight phrases, then automatically look them up on Internet portals such as Google or Wikipedia and search the entire text for specific words or phrases, amongst other things. The application can also give users the capability to highlight or underline the specific word being read, copy and paste selected phrases or words, allowing for voice notes to be saved on the app, changing voice tones as well as displaying images.

As can be seen in the figure, the word “Chromosomes” is highlighted in the text. A menu is overlaid on the text, with options for a user to perform based on the highlighted word. The example options shown are “add note,” “bookmark,” “Google,” and “Wikipedia.”

FIG. 9C shows an exemplary graphical user interface for selecting display options for the text according to an exemplary embodiment of the present invention. Options for a user to change settings are shown. Example settings which can be changed are font styles, sizes, spacing, alignment, backlight, and colors. Other options can include scroll speed, audio speed, line spacing, language, etc.

FIG. 9D shows an exemplary graphical user interface (GUI) for browsing an application according to an exemplary embodiment of the present invention. As shown in the GUI, users can be presented with selection for options for viewing the contents of TSA content, managing notes, managing settings, managing bookmarks, searching, managing images, and help. The search function can allow users to search for text within a title, but also search multiple titles based on a query to find titles with matching names, authors, and/or publishers. A query can specify keywords to match. Various help functions can include bug reports, feedback, frequently asked questions, current version information, etc.

FIG. 9E shows an exemplary graphical user interface (GUI) of a menu for actions on a note of a user according to an exemplary embodiment of the present invention. As shown in the GUI, the text of a note can be presented to the user and a menu shown for actions a user can take in connection with the note. Actions include, but are not limited to, email the note, play audio associated with the note, or post the note to a social networking site, such as, e.g., but not limited to Facebook, Twitter, etc.

FIG. 9F shows an exemplary graphical user interface of a user library according to an exemplary embodiment of the present invention. Users have a virtual library containing the TSA content belonging to them. The TSA content can be displayed as scrolls/titles, where each title corresponds to a book. Multiple titles can be displayed, along with the name of the title, cover art of a title, the last portion of the title read (e.g., last chapter read), the last date and time the title was read, and a button for sharing information regarding the title to a social networking site. Users can select titles from the virtual library to render the TSA content of the selected title. Users may also preview contents of a title before rendering the TSA content of a title.

Each user can have an account and the virtual library can be composed of all titles currently in the user's account. Users may view all previously purchased titles, archive existing titles to compress the titles on their device, uncompress existing titles, delete existing titles from their device, view available space on their device, and view space used on their device.

The virtual library can contain more than a title list for each user, it can contain user-specific information too. Some examples of user-based information are the current reading position of a title, the currently read title, statistics about the user's reading habits, the text size/speed/font/spacing preferences for the user, any bookmarks/notes/social networking information and other details. It can also allow the user to synchronize this information with multiple devices and readers. The library and user preferences can be available in a web-based reader, on multiple mobile devices and in PC-based applications by synchronizing the user's information with a central server. Having a virtual user account with custom preferences, reading positions, statistics, etc., solidifies and unifies the user experience on multiple reader platforms. In another embodiment, the user has both a virtual library and a virtual account (preferences, stars, etc) that is independent of the reader platform. In this way, the user could purchase content once and expect a unified experience across many platforms such that the user feels recognized across all delivery platforms. It is possible to use a single platform license model.

FIG. 9G shows an exemplary graphical user interface of a virtual shelf of a user according to an exemplary embodiment of the present invention. Users can arrange their titles in a virtual shelf where the cover art of the title is shown on shelves. Users can chose to add, remove, and order the titles on the self as they like. Access can also be given to other users to view one or more shelves of a user. The user can define other users who have access to one or more shelves.

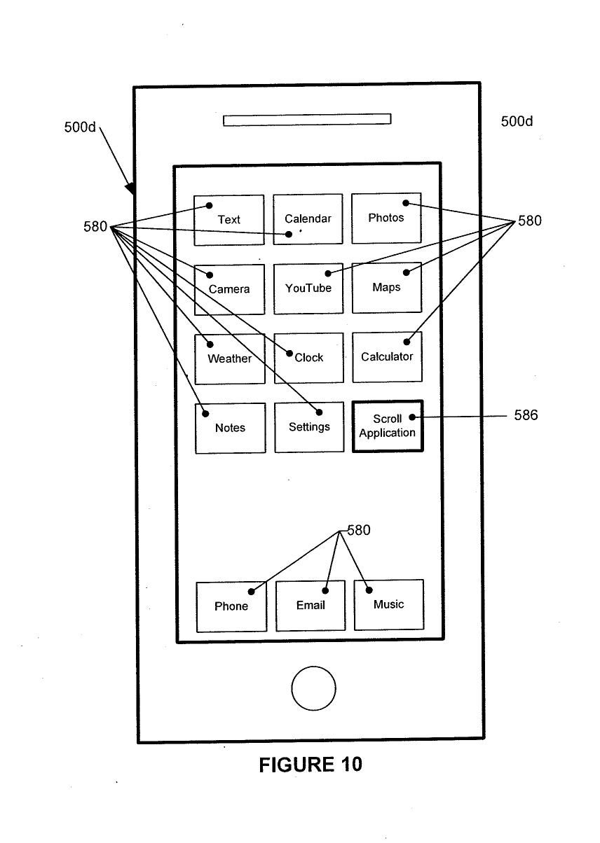

FIG. 10 shows an exemplary graphical user interface (GUI) of a device with an application for providing TSA content installed. In the figure, the application for rendering TSA content is named “Scroll Application.” The Scroll application can be one of many applications installed on the user device. The application can be launched by selecting the application in the GUI of the device.

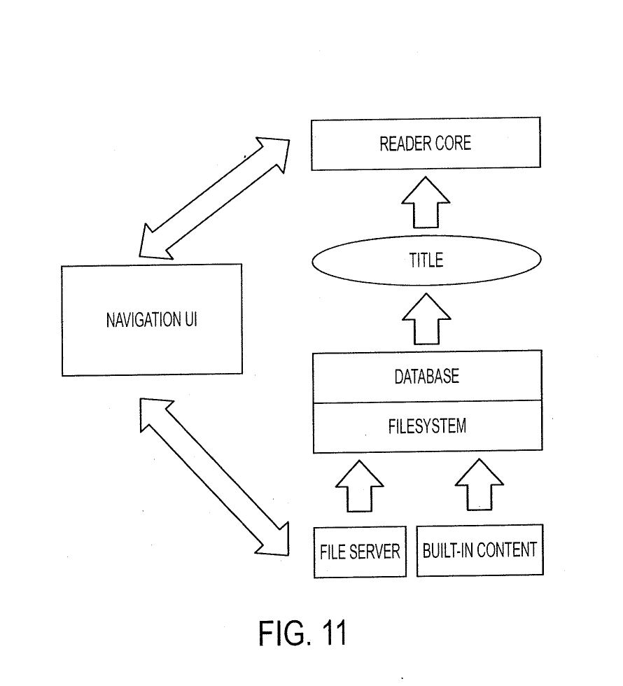

FIG. 11 shows an exemplary block diagram of a system using a core reader application according to an exemplary embodiment of the present invention. The application for rendering TSA content can be in multiple forms. In one form, an application can be specific to a single title, so that the application is only be used to play the TSA content of that title. Separate applications are needed for each title.

Alternatively, a single modular application can be used to render the TSA content. The single modular application comprises a reader core. The reader core loads TSA content from modules, each module corresponding to a title. The single modular application system is a highly modular design with a few core pieces. A central database keeps a record of all purchased titles and any user-specific title information, such as bookmarks, notes and the current reading position with the title. A Navigation User Interface retrieves data from the database and launches the reader core to display the desired title to the user.

Each title is an independent entity, accessible by any application component. Different components can query a Title object for information on its download state, table of contents, description or any specific user parameter. In one embodiment, the reader core interfaces with only a single title at a time, and is limited to the title that is selected by the Navigation User Interface.

Content is stored in a universal format in a local file system and is fetched from either a remote server or is built-in to the application bundle. The Navigation User Interface can browse content from the remote server and select content for downloading. Once content has been selected, a database entry is created for the Title and the content is brought into the local Filesystem either via a copy or an HTTP download operation.

FIGS. 12A and 12B show exemplary contents of an XML file containing information for TSA content. The XML file includes metadata providing information on the TSA content. All content is stored in a common package format. Each package represents a title and can be in the zipped or unzipped form. Example contents of each package are as follows
XML metadata file
A large, 768×1024 graphic image
A small, 60×80 graphic image
An icon, 57×57 graphic image
One compressed file per chapter consisting of a folder with the following content:
   A content file in HTML with audio time stamps for each word, this file is named content.html
   A mp3 audio file for the chapter, this file is named content.mp3

In a naming convention, each package is represented by a globally unique identifier (GUID). The name of the package folder, package .zip file and package .xml metadata file are equal to the unique package GUID. Each additional file in the package has a unique GUID-based name followed by an extension identifying the format of the file. The XML metadata file contains references to all files in the package. An example of such an XML metadata file is shown in FIGS. 12A and 12B.

The XML file includes information on the author, title, publisher, GUID, number of chapters, description, chapters, price, currency, and images for the package. For each chapter, the XML file also indicates the .zip file which corresponds to the TSA content for rendering that chapter and also for previewing that chapter.

The roles of the tags in the XML file shown are specifically described below. “Title” indicates that the contents represent a unique title. “Author” is the string representing the author of the title. “Titlename” is the string representing the display title. “GUID” is the unique GUID for the package. The GUID is also the name of the XML file and package folder. “Description” is a description to display to the user that describes the title, which may be in HTML format. “Chapters” indicate the beginning of the table of contents. “Section” delineates a hierarchal section in the table of contents. Parameters for section indicate the name and the title for a section. Each chapter in the table of contents can be represented by a unique content entry. Parameters of each unique content entry for a chapter are name representing the chapter name, zipfile representing the name of the compressed file for the chapter content, and previewfile representing the name of the compressed file for the chapter preview content. “Price” is the numeric price for the title. “Currency” is the currency for the price field. “Allinonezip”, if set to TRUE, indicates the package is downloaded and installed as one large compressed file with the name guid.zip. Otherwise “Allinonezip” indicates the package is downloaded by file. “Iconimage” specifies the name of the file to use as a 57×57 display icon. “Splashimage” specifies the name of the file to use as a 60×80 display icon. “Defaultimage” specifies the name of the file to use as a 768×1024 display image.

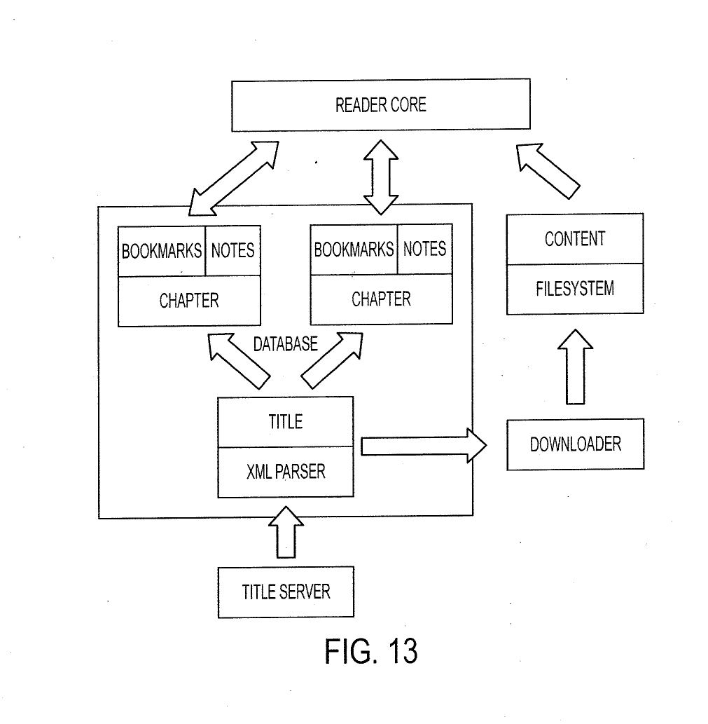

FIG. 13 shows an exemplary block diagram of dataflow in a system using a core reader application according to an exemplary embodiment of the present invention. In the example, all content is stored in packages that are described by a standardized XML file. Each content package corresponds to a single title in the application and the XML file contains information on all files in the package.

When content is provided by the Title Server, the corresponding XML file is read by the XML Parser. A Title is created for each package and a Chapter object for each entry in the table of contents. If the package consists of remote data, a background Downloader will fetch every file in the package and store the files in the local File System.

The Reader Core interfaces with the Database and retrieves title information to display to the user. Content is fetched by the Reader Core directly from the File System using file paths stored in each Chapter object.

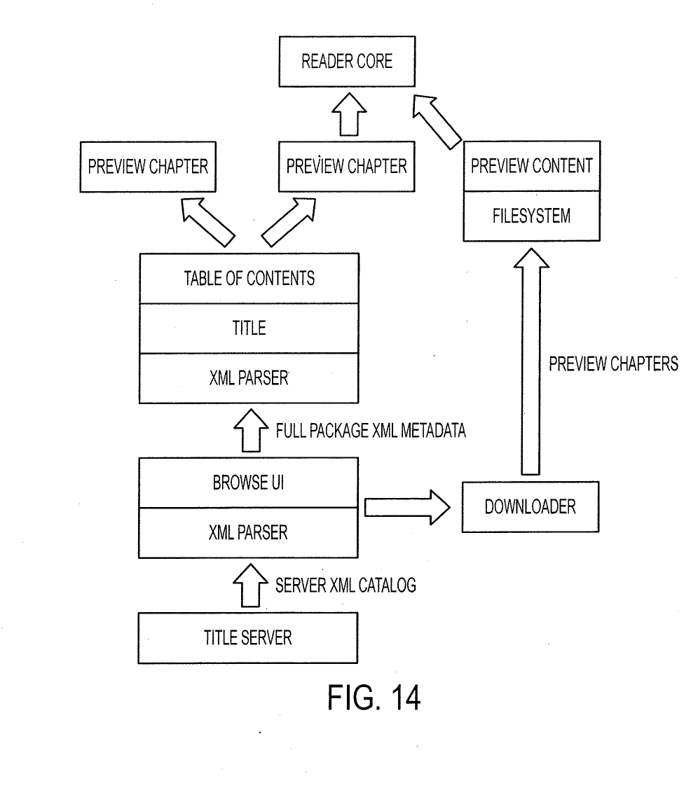

FIG. 14 shows an exemplary block diagram of a system for previewing TSA content using a core reader application according to an exemplary embodiment of the present invention. In the example, a remote server is used to store information about titles available for purchase and download. When a user browses for titles, an XML file describing all titles and categories in the title store is downloaded from the server. The initial XML contains basic title information, such as the name, author, price and display category.

If the user wants to view a specific title, the entire XML metadata file for that title is downloaded and the user can view all graphics, browse the table of contents, and download preview chapters, if available for that title. Once the purchase is complete the download of all content will initiate and the user can begin using their title. The previously downloaded content (graphics, XML metadata and table of contents) are preserved for either future use when browsing the title store (cached per launch) or are used for the purchased title (permanent).

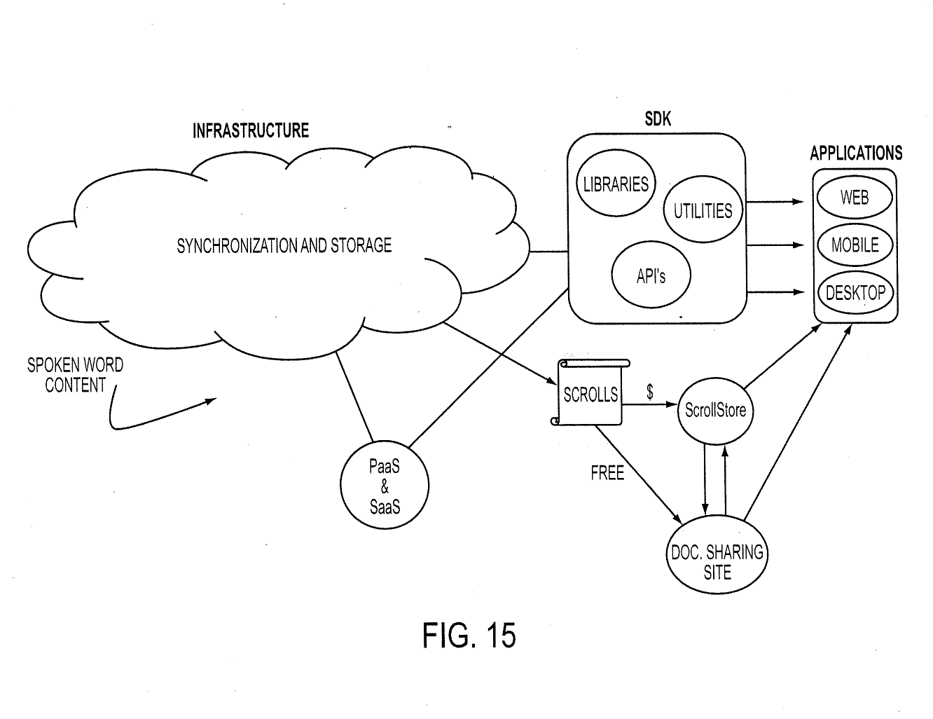

FIG. 15 shows an exemplary diagram of a system for providing TSA content according to an exemplary embodiment of the present invention. As shown in the diagram, spoken word content is synchronized and stored by infrastructure, which can also be known as the TSA content provider. Scrolls, also referred to as packages and titles, including the TSA content are then provided to a vendor that sells the scrolls, e.g., a ScrollStore, or provided to a distributor, such as, e.g., a document sharing site, that provides the scrolls. The vendors and distributors can also share scrolls between each other. The scrolls are then provided to applications which will render the TSA content to users.

Applications can include web based readers, mobile device based readers, or desktop based readers. These applications can utilize a Software Development Kit (SDK) to render the TSA content or interface with a server. The SDK includes libraries, utilities, and Application Programming Interfaces (API) for this purpose. For example, an SDK can be provided so that a plugin application for a software networking site can be created so users of the social networking site can interface with the TSA content provider.

The application may be downloaded directly from the Internet to the device, the application may be downloaded to a computer and then loaded on the device by, or the application can be distributed on any computer readable format.

The TSA content provider can also rely on cloud computing to provide TSA content to users. Example uses of cloud computing are Platform as a Service (PaaS) and Software as a Service (SaaS). The TSA content provider may also include a vendor and/or distributor.

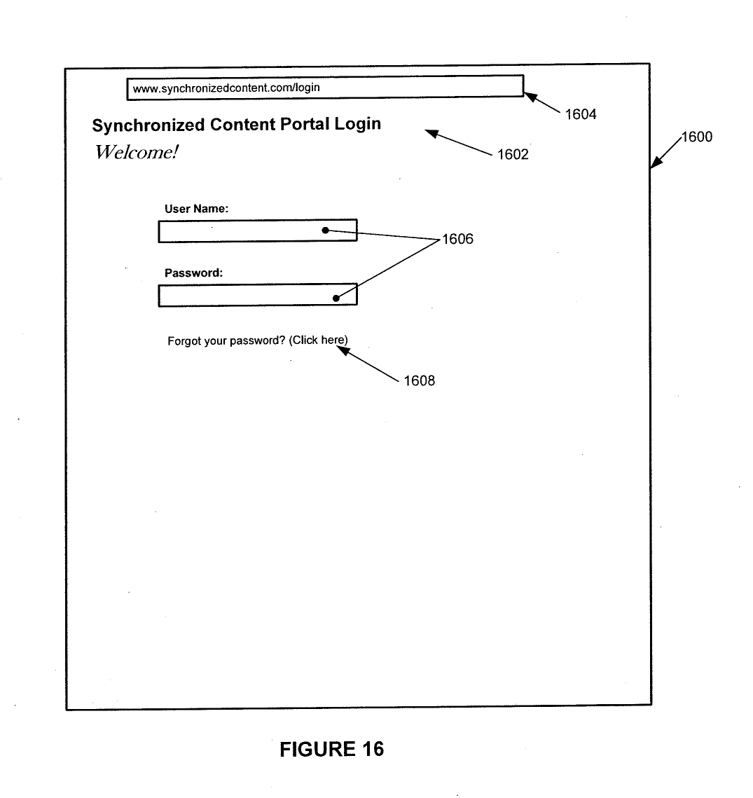

FIG. 16 shows another exemplary graphical user interface of a login to the TSA content portal according to an exemplary embodiment of the present invention. In this embodiment, a user, which may be any user referenced above, may log into an account with the TSA content provider by accessing a log-in portal, i.e. the TSA content portal. In this embodiment, the log-in portal identifies the TSA content provider at the top of the screen. The log-in portal is accessed by the user either through a link or by typing in an address into the web address line of a web browser. At the log-in portal a user is asked to supply a user identifier (such as name and password). The user identifier recognizes whether the user is registered within the TSA content provider to allow access to the user's account. Further, the user identifier authenticates content rights for the application on the user device and/or grants access rights to TSA content. The log-in portal further includes a help link for a user to click if the user has forgotten his/her user identifier. Users may also create new accounts and entire account information for a profile. The TSA content provider may also allow the user to link their account with a social networking account.

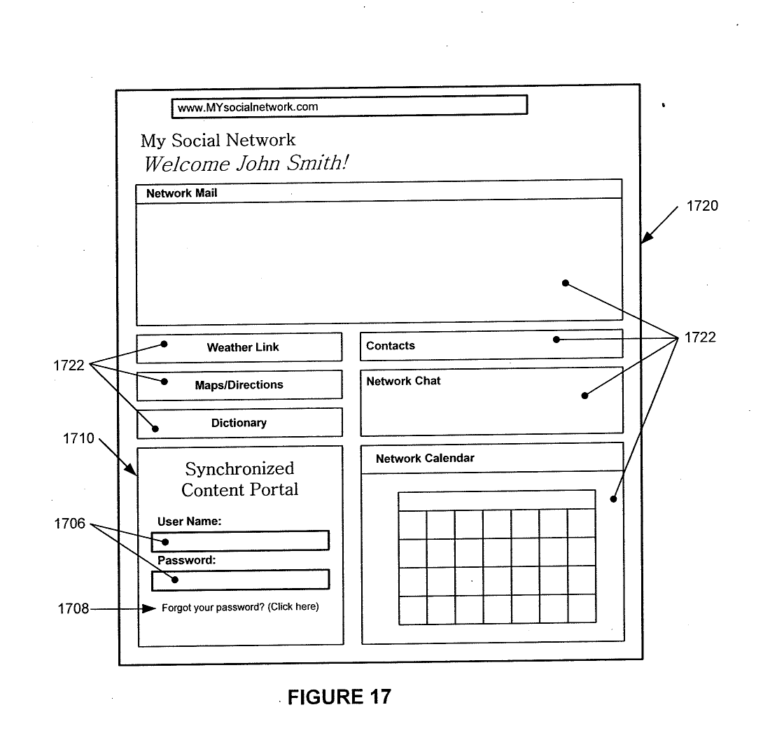

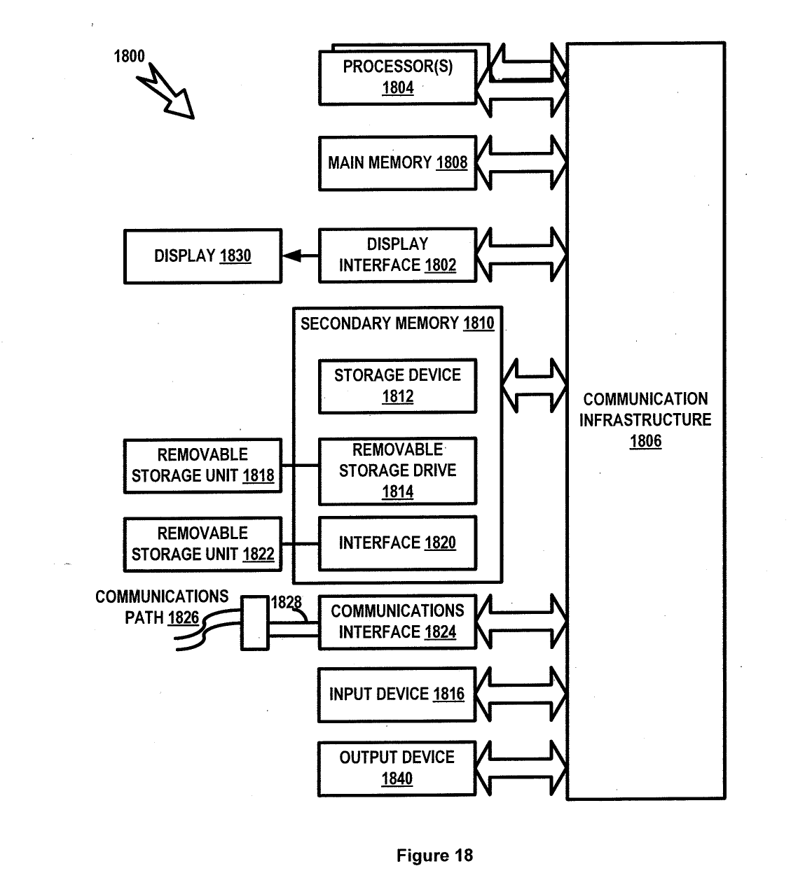

FIG. 17 shows another exemplary graphical user interface of a social networking with an integrated TSA content portal according to an exemplary embodiment of the present invention. In this embodiment, the user logs into a social networking site, i.e. My Social Network. The social networking site, My Social Network, provides a separate log-in link to TSA content, while allowing the user to take advantage of other social networking features, e.g., contact book, e-mail, or chat with friends, etc. Under this arrangement, the user is asked to supply a user identifier (such as name and password) in the TSA content log-in link. Thus, in this embodiment, a log-in portal for the social networking portal only grants the user access rights to the social networking portal. A separate log-in link for the TSA content grants access rights to the TSA content provider. In this embodiment, authenticated access rights to the TSA content provider grants further access rights to the TSA content of the user's account. The log-in portal further includes a help link for a user to click if he/she has forgotten his/her user identifier. Thus, each of the social networking site and TSA content provider require its own separate log-in procedure.

While various embodiments have been described above, it should be understood that they have been presented by way of example only, and not limitation. Thus, the breadth and scope of the described should not be limited by any of the above-described exemplary embodiments, but should instead be defined only in accordance with the following claims and their equivalents.

1. An execution method in a computer for synchronizing textual content that comprises a sequence of textual units with an audio content that comprises a sequence of sound units, comprising:
matching each of the sequence of sound units of the audio content with a corresponding textual unit of the sequence of textual units;
determining corresponding time of occurrence for each sound unit in the audio content relative to a time reference;
associating each matched textual unit with a tag that corresponds to the time of occurrence for the sound unit matched with the textual unit.

2. The execution method of claim 1, wherein matching comprises:
retrieving the textual content; and
comparing the textual units with the sound units.

3. The execution method of claim 2, wherein retrieving comprises:
receiving formatted information; and
converting the formatted information into the textual content.

4. The execution method of claim 2, wherein comparing comprises at least one of:
comparing the textual unit with a vocalization corresponding to the sound unit; or
comparing the sound unit with a transcription corresponding to the textual unit.

5. The execution method of claim 1, wherein matching comprises at least one of:
transcribing the sound unit as a corresponding matched textual unit; or
vocalizing the textual unit as the sound unit matching the textual unit.

6. The execution method of claim 1, wherein associating comprises:
tagging each textual unit with a tag; and
associating the tag with the time of occurrence for the sound unit matched with the textual unit.

7. The execution method of claim 6, further comprising:
outputting TSA content comprising the sound units and tag associated textual units.

8. The execution method of claim 1, wherein the sequence of sound units comprise at least one of:
a plurality of phoneme;
a plurality of syllables;
a plurality of words;
a plurality of sentences; or
a plurality of paragraphs.

9. The execution method of claim 1, wherein the sequence of textual units comprise at least one of:
a plurality of signs;
a plurality of symbols;
a plurality of letters;
a plurality of characters;
a plurality of words;
a plurality of sentences; or
a plurality of paragraphs.

10. A system, comprising:
an audio content input configured to receive audio content that comprises a sequence of sound units;
a textual content input configured to receive textual content that comprises a sequence of textual units; and
a synchronizer that synchronizer that synchronizes the textual content with audio content, comprising:
a matcher configured to match each of the sequence of sound units of the audio content with a corresponding textual unit of the sequence of textual units; and
a timer configured to determine a corresponding time of occurrence for each identified sound unit in the audio content relative to a time reference, wherein each matched textual unit is associated with a tag that corresponds to the time of occurrence for the sound unit matched with the textual unit.

11. The system of claim 10, wherein the matcher is configured to:
retrieve the textual content; and
compare the textual units with the sound units.

12. The system of claim 11, wherein the matcher is configured to:
receive formatted information; and
convert the formatted information into the textual content.

13. The system of claim 11, wherein the matcher is configured to at least one of:
compare the textual unit with a vocalization corresponding to the sound unit; or
compare the sound unit with a transcription corresponding to the textual unit.

14. The system of claim 10, wherein the matcher is configured to at least one of:
transcribe the sound unit as a corresponding matched textual unit; or
vocalize the textual unit as the sound unit matching the textual unit.

15. The system of claim 10, wherein the synchronizer is configured to:
tag each textual unit with a tag; and
associate the tag with the time of occurrence for the sound unit matched with the textual unit.

16. The system of claim 10, further comprising:
a TSA output configured to output TSA content comprising the sound units and tag associated textual units.

17. A method of rendering TSA content comprising textual content having a sequence of textual units and audio content having a sequence of sound units, comprising:
retrieving the TSA content;
retrieving tags associated with the textual units, each said tag corresponding to a time of occurrence of the sound unit in the audio content matching the textual unit;
rendering the audio content; and
showing the textual unit on a display based on the rendering of the audio content according to the time of occurrence of the sound unit in the audio content matching the textual unit.

18. The method of rendering of claim 17, wherein showing comprises:
highlighting the textual unit on the display based on the rendering of the audio content according to the time of occurrence of the sound unit in the audio content matching the textual unit.

19. The method of rendering of claim 17, further comprising receiving an input corresponding to a textual unit of the textual content, wherein rendering the audio content comprises:
rendering the audio content based on the time of occurrence corresponding to the tag associated with the textual unit.
